(19) United States
(12) Patent Application Publication
(10) Pub. No.: US 2016/0168025 A1
(43) Pub. Date: Jun. 16, 2016

(54) Method for Making A Reinforced Downhole Tool Component

(71) Applicant: Schlumberger Technology Corporation, Sugar Land, TX (US)

(72) Inventors: Nozomu Nishihara, Sagamihara-shi (JP); Akira Kamiya, Sagamihara-shi (JP)

(21) Appl. No.: 14/961,894

(22) Filed: Dec. 8, 2015

Related U.S. Application Data
(60) Provisional application No. 62/090,856, filed on Dec. 11, 2014.

(51) Int. Cl. C03C 29/00; E21B 17/02

(52) U.S. Cl. CPC C03C 29/00; E21B 17/028

(57) ABSTRACT

A method for making a reinforced downhole tool component that can be sealed against a large pressure differential is disclosed. The method comprises providing an item for the component, applying a heat treatment to melt a glass material for sealing on the item, cooling down the item gradually to room temperature, and applying a heat treatment for an age hardening on the item.

### CROSS-REFERENCE TO RELATED APPLICATIONS

This application is based upon and claims the benefit of the priority of U.S. Provisional Application Ser. No. 62/090,856 entitled “METHOD FOR MAKING A REINFORCED DOWNHOLE TOOL COMPONENT” filed on Dec. 11, 2014, the disclosure of which is incorporated herein in its entirety by reference thereto.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

The present disclosure relates generally to methods for making of components of downhole tools used in wellsite operations. In particular, the present disclosure relates to methods for making downhole tool components with a glass sealing process.

The glass sealing process includes a heat treatment at high temperature around 1000 deg. C so that glass material for sealing can melt. This present disclosure handles a heat profile so as to add an age hardening on metal during or after the glass seal process. Basically for most age hardening type metal, a specific heat treatment is usually implemented, which includes at first solution annealing at around 1000 deg. C for a few hours, then water quench and then an age hardening at 600 deg. C-700 deg. C for a few hours to several dozen hours. After the specific age hardening process, the metal can obtain certain strength, i.e., is reinforced.

However, for the glass seal process, glass material is usually melted at a temperature around 1000 deg. C. Then, the glass material is gradually cooled down to room temperature with avoiding any damage such as crack on glass. And if a heat profile for glass seal is applied on the metal which has been already age-hardened, it resets age hardening effect and strength of metal becomes very low. It could lead to the insufficient strength of the metal and it may not be able to be used as a product which needs to hold pressure and/or any force applied on it.

As will become apparent from the following description and discussion, the present disclosure provides improved methods of sealing process in downhole applications.

### SUMMARY OF THE DISCLOSURE

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect of the present disclosures, a method for making a reinforced downhole tool component comprises providing an item for the component, applying a heat treatment to melt glass material for sealing on the item, cooling down gradually to room temperature, and applying a heat treatment for an age hardening on the item.

The heat treatment for melting the glass material may be applied at a temperature around 1000 deg. C. The heat treatment for the age hardening may be applied after a glass sealing process or during a glass sealing process. The heat treatment may be also controlled by a temperature-time profile. The temperature-time profile is based on at least one of properties of the glass material or at least one of properties of the item. The at least one of properties of the glass material may be at least one of a glass transition temperature and a glass softening temperature. The heat treatment for the age hardening may be applied at a temperature range from about 600 deg. C to about 800 deg. C. The heat treatment may be also applied in a time range from about 1 hour to about 5 hours.

The item may comprise an age hardening type metal. The metal may comprise a variety materials such as metals belonging to a SUS600 series metal, Inconel series (Ni—Cr alloy) metal, Hastelloy series (Ni—Cr—Mo alloy) metal or Be Cu metal. The age hardening type metal may in some embodiments be an Inconel 718 metal.

The downhole tool component produced by the method in the present disclosures may be a glass sealed bulk head connector.

Advantages and novel features of the disclosures will be set forth in the description which follows or may be learned by those skilled in the art through reading the materials herein.

### BRIEF DESCRIPTION OF THE DRAWINGS

Embodiments of seal assemblies and apparatuses having the same according to the disclosures herein are described with reference to the following figures. The same numbers are used throughout the figures to reference like features and components.

FIGS. 1A and 1B depict schematic views, partially in cross-section, of a wellsite with a downhole drilling tool and a downhole wireline tool, respectively, deployed into a wellbore implemented in accordance with embodiments of the present disclosure;

FIG. 2 depicts a block diagram of a process for making a reinforced component in accordance with embodiments of the present disclosure;

FIG. 3 depicts an example of temperature-time profile in a heat treatment for glass sealing;

FIG. 4 depicts an example of temperature-time profile in a heat treatment for an age hardening of Inconel 718;

FIG. 5 depicts an example of age hardening characteristics for Inconel 718 showing temperature and time vs. hardness (HRC) of the age hardening processes;

FIG. 6 depicts an application example of a glass sealed bulkhead connector in accordance with embodiments of the present disclosure;

FIGS. 7A, 7B and 7C depict a top view, a longitudinal cross section and a bottom view of a sample of downhole tool component, respectively, showing hardness inspection areas in accordance with embodiments of the present disclosure.

### DETAILED DESCRIPTION

Illustrative embodiments and aspects of the present disclosure are described below. In the interest of clarity, not all features of an actual implementation are described in the specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such development effort might be complex and time-consuming, but would nevertheless be a routine undertaking for those of ordinary skill in the art having benefit of the disclosure herein.

The material limitations and costs associated with manufacturing high performance downhole tools as noted above can be reduced by a method of making downhole tools as described hereunder. By using the disclosed method comprising steps in a certain order can enhance primarily with respect to strength to a level that renders them acceptable for use as high performance downhole tools. Currently, as will be recognized by one of ordinary skill in the art, there are limitations to the strength of these suitable corrosion resistant alloys utilized in high pressure or highly corrosive environments within a wellbore.

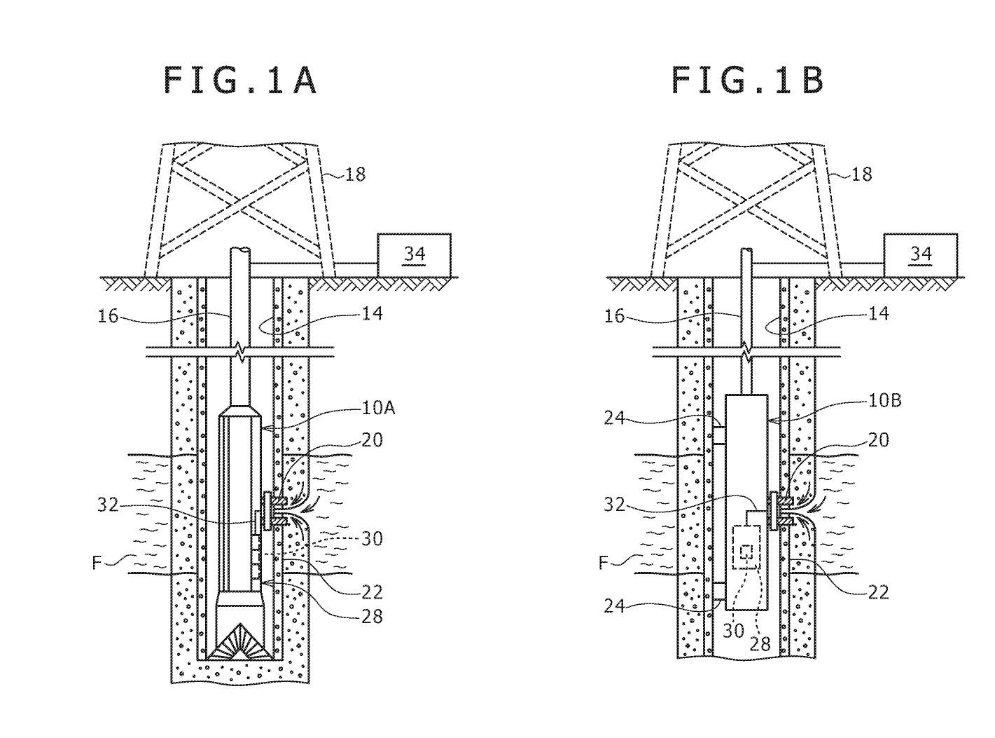

FIGS. 1A and 1B depict environments in which subject matter of the present disclosure may be implemented. FIG. 1A depicts a downhole drilling tool 10A and FIG. 1B depicts a downhole wireline tool 10B that may be used for performing formation evaluation. The downhole drilling tool 10A may be advanced into a subterranean formation F to form a wellbore 14. The downhole drilling tool 10A may be conveyed alone or among one or more (or itself may be) measurement-while-drilling (MWD) drilling tools, a logging-while-drilling (LWD) drilling tools, or other drilling tools. The downhole drilling tool 10A is attached to a conveyor (e.g., drill string) 16 driven by a rig 18 to form the wellbore 14. The downhole drilling tool 10A includes a probe 20 adapted to seal with a wall 22 of the wellbore 14 to draw fluid from the formation F into the downhole drilling tool 10A as depicted by the arrows.

The downhole drilling tool 10A may be withdrawn from the wellbore 14, and the downhole wireline tool 10B of FIG. 1B may be deployed from the rig 18 into the wellbore 14 via conveyance (e.g., a wireline cable) 16. The downhole wireline tool 10B is provided with a probe 20 adapted to seal with the wellbore wall 22 and draw fluid from the formation F into the downhole wireline tool 10B. Backup pistons 24 may be used to assist in pushing the downhole wireline tool 10B and probe 20 against the wellbore wall 22 and adjacent the formation F.

The downhole tools 10A, 10B may also be provided with a formation evaluation tool 28 with an optical sensor assembly 30 for measuring parameters of the formation fluid drawn into the downhole tool 10A, 10B. The formation evaluation tool 28 includes a flowline 32 for receiving the formation fluid from the probe 20 and passing the fluid to the optical sensor assembly 30 for measurement as will be described more fully herein. A surface unit 34 may be provided to communicate with the downhole tools 10A, 10B for passage of signals (e.g., data, power, command, etc.) there between.

A glass sealing process is one of manufacturing processes for making a downhole tool component used in a downhole tool such as the foregoing downhole drilling tool and downhole wireline tool. In general, embodiments of downhole tool components may be any high pressure rated fluid analysis sensors, any high pressure rated Bulkhead connectors, or other types of components not expressly listed that need to withstand high pressure differences. Generally, the glass sealing process includes a heat treatment at high temperature around 1000 deg. C which is to melt glass material for sealing. However it may make age hardening type metal in the downhole tool component have low strength because metal's solution annealing temperature is also around 1000 deg. C. Therefore, by adding a heat treatment on the metal after the glass sealing process or by controlling temperature-time profile during the glass sealing process, the metal can obtain higher strength and suitable hardness and strength of the metal can be selected. The temperature-time profile can be controlled depending on at least one of glass seal material's properties and metal's age hardening properties.

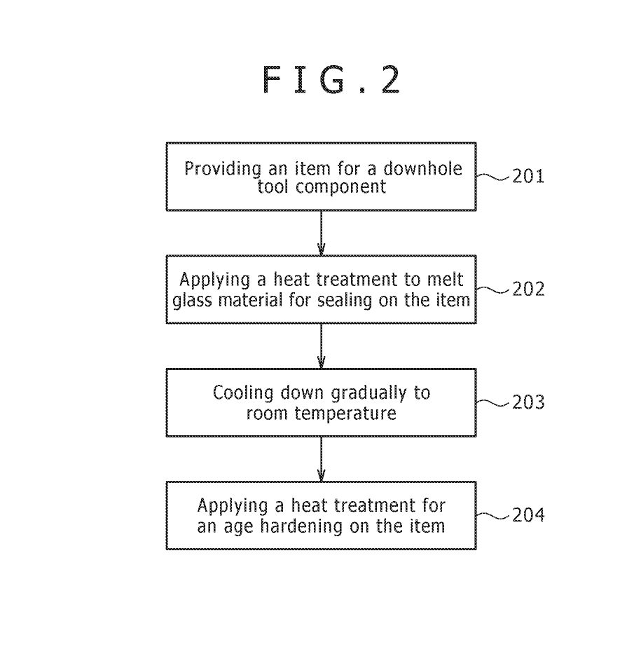

One embodiment of methods for making a reinforced downhole tool component according to the present disclosures relates to a heat profile, i.e., which is also called a temperature-time profile, to add age hardening on the metal of downhole tool component after glass seal process. Referring to FIG. 2, a block diagram of a manufacturing process for making a reinforced downhole tool component in accordance with the disclosure is illustrated. Manufacturing step 201 provides an item for a downhole tool component. As one of ordinary skill in the art should understand, providing 201 may include, but is not limited to, forging or rough machining of material for the item. The item has glass material for sealing. Next, manufacturing step 202 applies a heat treatment at a temperature about 1000 deg. C to melt the glass material on the item. Then, step 203 cools down the item gradually to room temperature with avoiding any damage such as crack on the glass material. Finally, step 204 applies a heat treatment for an age hardening on the item. In another embodiment, the heat treatment for age hardening can be applied during a glass sealing process. When applying the heat treatments for age hardening at the same time as a glass sealing process, overall process time can be reduced and provide a costs savings.

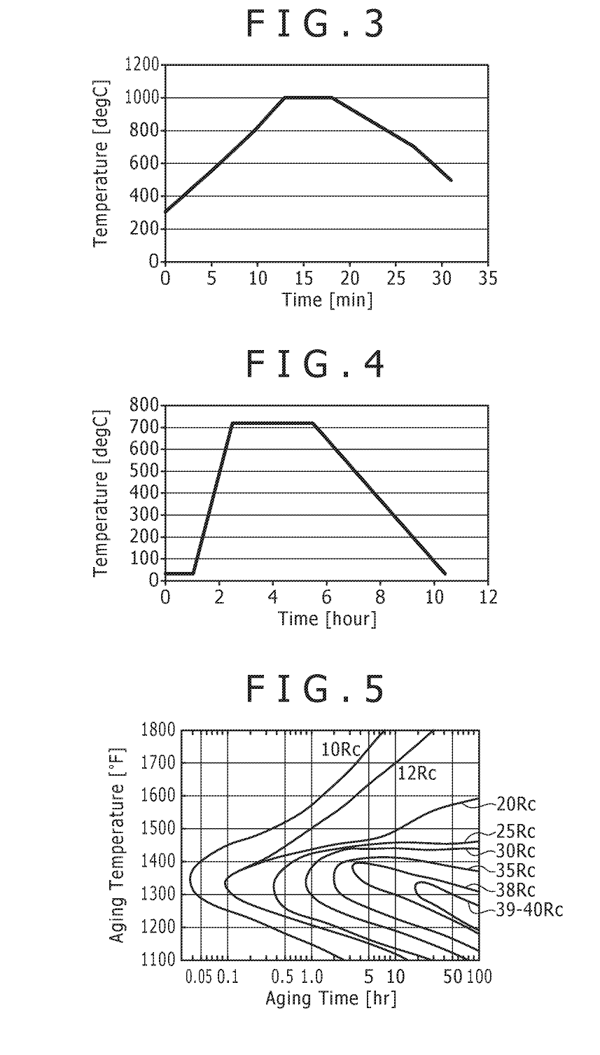

Accordingly, the age hardening after the glass sealing process or during the glass sealing process disclosed herein is useful process to realize a glass sealed metal part in the downhole tool component with high strength. As one example, Inconel 718 is one of age hardening type metals which can be used as material of the item for downhole tool component. After a glass sealing process with a heat treatment of a temperature-time profile as shown in FIG. 3, strength of the metal material (Inconel 718) becomes very low, i.e., Rockwell hardness (HRC) of the metal material (Inconel 718) is HRC 20 which is equivalent to tensile strength of 760 MPa approximately as showing in Table 1, before a heat treatment for an age hardening.

TABLE 1

| Hardness (HRC) | Tensile strength (MPa) |
|---|---|
| (10) | 620 |
| 20 | 760 |
| 30 | 950 |
| 40 | 1250 |

On the basis of the foregoing results, in the method disclosed in this disclosure, a heat treatment for an age hardening with a temperature-time profile as shown in FIG. 4 is applied after glass sealing process. After the heat treatment for age hardening, strength of the metal material (Inconel 718) becomes very high, i.e., Rockwell hardness (HRC) of the metal material (Inconel 718) is HRC 40 which is equivalent to tensile strength of 1250 MPa approximately. An appropriate temperature-time profile for the age hardening can be decided based on at least one of properties of the metal material such as an age hardening characteristics. The heat treatment for age hardening may be applied during the glass sealing process.

The method disclosed in this disclosure can be applied on any age hardening type metal on which glass sealing can be usually applied. And it allows us to obtain glass sealing and high metal strength at same time. Depending on at least one of properties of the glass material such as glass transition temperature, softening temperature, etc. and age hardening profile as shown in FIG. 5, a temperature-time profile for the age hardening may be adjusted from several tests of metal hardness and glass seal performance after this process.

Applicable metals by this disclosure can cover SUS600 series (SUS630, SUS631 and etc.), Inconel series (Ni—Cr alloy), Hastelloy series (Ni—Cr—Mo alloy) and Be CU metal and so on.

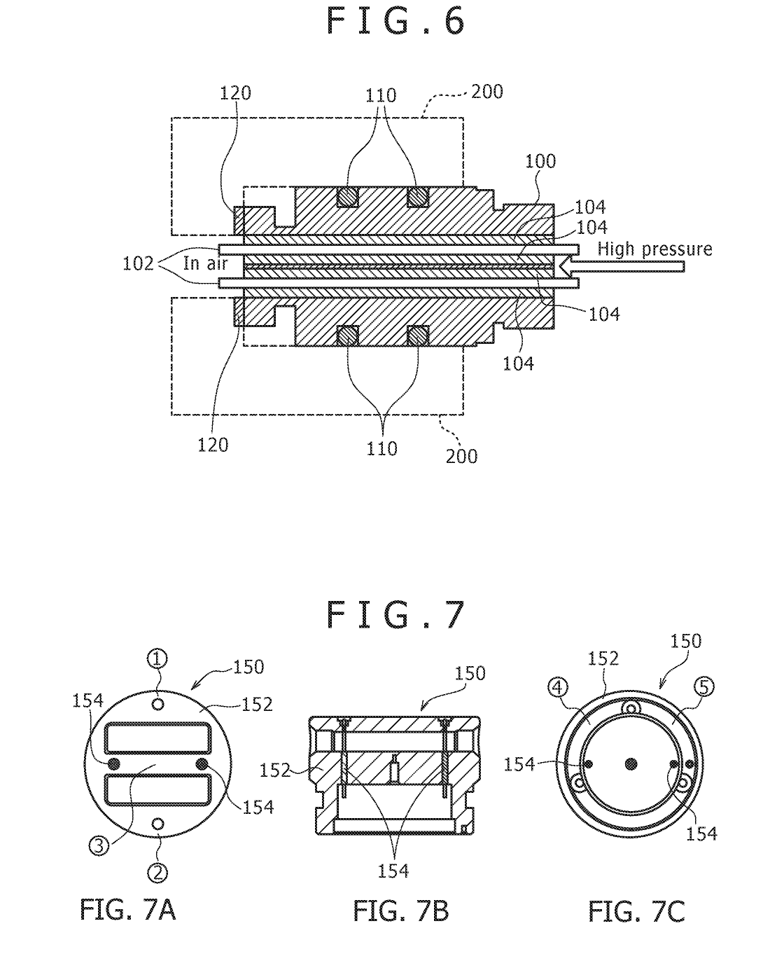

FIG. 6 depicts an application example of a glass sealed bulkhead connector in accordance with embodiments of the present disclosure. In this example, a bulkhead connector 100 is installed in a downhole tool body 200 by sealing between inside in air (atmospheric pressure) and outside in high pressure with O-rings 110. Each of through holes including a pin 102, which is used for electrically connection between the inside and outside, is sealed with glass material 104 for sealing.

Referring to FIG. 6, with regard to the downhole tool component produced by the disclosure, the contact area 120 between the bulkhead connector 100 and the downhole tool body 200 can be reduced by increasing strength of the metal material used for the glass sealed bulkhead 100, then the glass sealed bulkhead 100 can also be downsized in limited space of downhole tools.

As a reference of an embodiment disclosed in this disclosure, Table 2 shows a result of hardness for glass sealing process combined with a heat treatment for an age hardening applied on a sample item of metal material of Inconel 718 in accordance with this disclosure. The inspection area No. is shown in FIGS. 7A-7C which illustrate an example of items of downhole tool component 150 which has a body 152 of the metal material (Inconel 718) with two glass sealed pins 154. The Rockwell hardness (HRC) is inspected at five inspection areas (No. 1-5) on the body 152. The result in Table 2 shows that the hardness (HRC) of the metal material (Inconel 718) can be improved by adding the heat treatment for age hardening.

TABLE 2

| | Rockwell Hardness [HRC] | | | | |
|---|---|---|---|---|---|
| | Inspection area No. | | | | |
| | 1 | 2 | 3 | 4 | 5 |
| After glass sealing | 4.8 | 11.8 | 19.6 | 19.9 | 15.5 |
| After heat | 24.6 | 25.6 | 31.2 | 35.1 | 28.4 |
| treatment for age | | | | | |
| hardening | | | | | |

According to one embodiment of this disclosure, the comparatively less expensive materials can be modified to exhibit required properties of strength and corrosion resistance sufficient to either equal or exceed current requirements for service.

The preceding description has been presented only to illustrate and describe certain embodiments. It is not intended to be exhaustive or to limit the disclosures to any precise form disclosed. Many modifications and variations are possible in light of the above teaching.

The embodiments and aspects were chosen and described in order to best explain principles of the disclosures and its practical applications. The preceding description is intended to enable others skilled in the art to best utilize the principles in various embodiments and aspects and with various modifications as are suited to the particular use contemplated. It is intended that the scope of the disclosures be defined by the following claims.

What is claimed is:

1. A method for making a reinforced downhole tool component, comprising:
providing an item for the component;
applying a heat treatment to melt glass material for sealing on the item;
cooling down the gradually to room temperature; and
applying a heat treatment for an age hardening on the item.

2. The method according to claim 1, wherein the heat treatment for melting the glass material is applied at a temperature around 1000 deg. C.

3. The method according to claim 1, wherein the heat treatment for the age hardening is applied after a glass sealing process.

4. The method according to claim 1, wherein the heat treatment for the age hardening is applied during a glass sealing process.

5. The method according to claim 1, wherein the heat treatment is controlled by a temperature-time profile.

6. The method according to claim 5, wherein the temperature-time profile is based on at least one of properties of the glass material.

7. The method according to claim 6, wherein the at least one of properties of the glass material is at least one of a glass transition temperature and a glass softening temperature.

8. The method according to claim 5, wherein the temperature-time profile is based on at least one of properties of the item.

9. The method according to claim 1, wherein the heat treatment for the age hardening is applied at a temperature range from about 600 deg. C to about 800 deg. C.

10. The method according to claim 1, wherein the heat treatment is applied in a time range from about 1 hour to about 5 hours.

11. The method according to claim 1, wherein the item comprises an age hardening type metal.

12. The method according to claim 11, wherein the age hardening type metal comprises at least one of the following metals: SUS600 series metal, Inconel series (Ni—Cr alloy) metal, Hastelloy series (Ni—Cr—Mo alloy) metal or Be Cu metal.

13. The method according to claim 12, wherein the age hardening type metal comprises a metal of Inconel 718.

14. A downhole tool component produced by the method according to claim 1.

15. The downhole tool component according claim 14, wherein the component is a glass sealed bulk head connector.
